(19) United States
(12) Patent Application Publication
(10) Pub. No.: US 2017/0095100 A1
(43) Pub. Date: Apr. 6, 2017

(54) DISPOSABLE EATING UTENSIL

(71) Applicant: Robert W. WHITE, Bloomingdale, NJ (US)

(72) Inventor: Robert W. WHITE, Bloomingdale, NJ (US)

(21) Appl. No.: 15/274,448

(22) Filed: Sep. 23, 2016

Related U.S. Application Data
(60) Provisional application No. 62/222,583, filed on Sep. 23, 2015.
(60) Provisional application No. 62/291,009, filed on Feb. 4, 2016.

(51) Int. Cl. A47G 21/02; A47G 21/06; B26B 3/02; A47G 21/04

(52) U.S. Cl. CPC A47G 21/02; A47G 21/04; A47G 21/06; B26B 3/02; A47G 2200/08; A47G 2200/143; A47G 2200/16; A47G 2200/186; A47G 2200/205

(57) ABSTRACT

An eating utensil, such as a disposable utensil, may include a fork, knife, or spoon, or a combination thereof with a construction aimed at substantially reducing the weight of the utensil while vastly increasing the structural integrity of the utensil. The utensil may be formed from a polymeric or other material(s) in a singular or multi-piece construction bonded or otherwise adhered to one another to form a singular utensil with desirable physical properties. Such a utensil will not only be more resilient for the consumer, but the reduced material usage in the construction of the utensil will enable the producers to save money in material costs.

### CLAIM OF PRIORITY

This application claims the priority of U.S. Ser. No. 62/222,583 filed on Sep. 23, 2015 and U.S. Ser. No. 62/291,009 filed on Feb. 4, 2016, the contents of which are fully incorporated herein by reference.

### FIELD OF THE EMBODIMENTS

The field of the embodiments of the present invention relate to disposable eating utensils, and more particularly to a utensil designed to be both lightweight and strong.

### BACKGROUND OF THE EMBODIMENTS

An estimated 40 billion plastic utensils are used every year in the United States alone, representing almost one billion pounds of plastic waste created every year. Plastic cutlery is non-biodegradable, and the majority of such utensils are thrown out after just a single use. The reduction of the plastic or other material comprising the individual utensils can significantly reduce the amount of waste produced from the discarding of disposable utensils. Further, the reduction of the amount of material used in disposable utensils can significantly reduce the cost of manufacture as well as any associated costs borne by the consumer.

Disposable plastic utensils of various size and shapes are known. There have been various attempts at making the utensils lighter and cheaper to manufacture. However, the utensils typically get more pliable and less structurally sound as the amount of plastic is reduced. The known structural design for the handle and head of the utensils is typically of a U-shape and rib construction. The single piece construction methodology and structure associated with these designs limited the amount of material that can be removed from the overall construction of the utensil. Further, it is contemplated that disposable utensils can be manufactured from environmentally sound materials such as recyclable and biodegradable materials such as metals, plastics, wood products, paper, plant starches, or other suitable materials or some combination thereof. These biodegradable materials can further be coated with waxes or other materials to make them water resistant while being used as an eating utensil.

### REVIEW OF RELATED TECHNOLOGY

U.S. Pat. No. 6,055,733 pertains to an extensible cutlery device that has a hollow tube, a first casing disposed in the hollow tube, a second casing disposed in the hollow tube, and a fork device disposed between the first casing and the second casing. The first casing engages with the second casing. The fork device has a handle inserted in a spacing defined between the first casing and the second casing. A drive mechanism drives the fork device to extend and retract. A plug seat has two hook ends inserted in a rear end of the hollow tube.

U.S. Pat. No. 2,941,292 pertains to a hollow handle knife. The knife has a handle comprising two mirror images of one another that is joined through conventional methods such a soldering. The knife comprises two sections which when brought together form the utensil when joined. However, such a construct is limited in strength and overall rigidity when compared to that of the present invention.

U.S. Patent Application 2008/0016698 pertains to an illuminated washable spoon that includes a main spoon body having a concave distal portion and a handle portion. The handle portion is hollow and has a depressible section adapted to depress when the handle portion is held. An illumination mechanism is located within the handle portion. The illumination mechanism includes a power source, an on/off pressure switch and a light. The on/off pressure switch is located at the depressible section of the handle portion such that when the handle portion is held, force toward the handle portion caused by the holder depresses the depressible section, activating the pressure switch and illuminated the light.

Various devices are known in the art. However, their structure and means of operation are substantially different from the present disclosure. The other inventions fail to solve all the problems taught by the present disclosure. The inventor, here, has surprisingly found that by creating a hollow utensil, the strength of the utensil as a whole can be substantially increased while greatly decreasing the overall amount of material required to fashion the utensil. At least one embodiment of this invention is presented in the drawings below and will be described in more detail herein.

### SUMMARY OF THE EMBODIMENTS

In general the present invention and its embodiments provide for disposable utensils that have an increased strength profile and a decrease in the amount of material comprising the utensil when compared to traditional utensils. Embodiments of the present invention may have a first section and a second section with an interstitial space or gap there between. The thickness of the walls of the sections along with the manner of coupling are selected to impart maximum load bearing and overall strength while maintaining a minimalist construction.

The bending stresses of various disposable utensils, during use, are carried by the outside structure of the design. The present invention and its embodiments allows for a stiffer product with reduced weight. The bonding area is preferably at the midsection, between the sections, of the utensil since that is at the lowest stress area of the design. Additionally, utensils may be constructed of sections with variable side wall heights. Utensils may be made from varying materials such as plastics, papers, metals, and the like or any combination thereof. Utensils may have a single layer planer top or bottom with a conversely formed top or bottom section. Utensils manufactured using mixed material such as paper and plastic, as noted, may also be used for reduction in cost and being more environmentally friendly.

In one embodiment of the present invention there is an eating utensil comprising: a first section substantially bearing a shape of a utensil, wherein the first section has a first coupling surface disposed around a periphery of the first section; a second section having a shape that is substantially the same as the first section, wherein the second section has a second coupling surface disposed around a periphery of the second section; and wherein the first section and the second section are coupled along at least a portion of the first and the second coupling surface.

In another embodiment of the present invention there is a disposable utensil comprising: a first section substantially bearing a shape of a utensil, a second section of a shape that is substantially the same as the first section with portions of reduced size and shape to further reduce the amount of material while maintaining superior structural integrity when coupled together along at least a portion of the first and second coupling surfaces.

In another embodiment of the present invention there is an eating utensil having a first section substantially bearing a shape of a utensil, wherein the first section has a first coupling surface disposed around a periphery of the first section; a second section having a shape that is substantially the same as the first section, wherein the second section has a reduced size and shape, wherein the first section and the second section are coupled along at least a portion of the first and the second coupling surface.

In yet another embodiment the exterior wall of the first section slides within the inner wall of the second section.

In yet another embodiment of the present invention there is a disposable utensil comprising a polymeric material forming a utensil body defining an interstitial space therein, the polymeric shell having a thickness of about 0.2 mm to about 0.8 mm, wherein the utensil is configured to distribute a load around a periphery of the utensil.

In general, the present invention succeeds in conferring the following, and others not mentioned, benefits and objectives.

It is an object of the present invention is to provide a disposable eating utensil that is lightweight and strong.

It is another object of the present invention to provide a disposable eating utensil that is inexpensive to manufacture.

It is another object of the present invention to provide a disposable eating utensil with less material than typical utensils.

It is another object of the present invention to provide a disposable eating utensil manufactured as a single piece construction with an interstitial space.

It is another object of the present invention to provide a disposable eating utensil manufactured from a two-piece construction which is bonded together using glue, adhesives, sonic welding, solvent welding, or any like process.

It is another object of the present invention to provide a disposable eating utensil manufactured from a plurality of components which is bonded together

It is another object of the present invention to provide a disposable eating utensil manufactured from a plurality of components that snap together.

It is another object of the present invention to provide a disposable eating utensil manufactured with an interlocking edge.

It is another object of the present invention to provide a disposable eating utensil manufactured with alignment features for assembly.

It is another object of the present invention to provide a disposable eating utensil manufactured with additional ribs for increase structural strength.

It is another object of the present invention to provide a disposable eating utensil manufactured biodegradable materials such as plastics, wood products, paper, plant starches, or other suitable materials.

It is another object of the present invention to provide a disposable eating utensil manufactured using injection molding, blow molding, rotary molding, vacuum forming or any other suitable manufacturing method.

### BRIEF DESCRIPTION OF THE DRAWINGS

FIG. 1 is an exploded isometric view of a first embodiment of the present invention as shown from the top of the utensil.

FIG. 2 is an exploded isometric view of a first embodiment of the present invention as shown from the bottom of the utensil.

FIG. 3 is an isometric view of a first embodiment of the present invention assembled in accordance with the present invention.

FIG. 4 is a cross sectional view of a first embodiment of the present invention demonstrating the structure of the embodiment as a whole.

FIG. 5 is an exploded isometric view of a second embodiment of the present invention as shown from the top of the utensil.

FIG. 6 is an isometric view of a second embodiment of the present invention assembled in accordance with the present invention.

FIG. 7 is sectional view of a second embodiment of the present invention demonstrating the structure of the embodiment as a whole.

FIG. 8 is an isometric view of a third embodiment of the present invention assembled in accordance with the present invention.

FIG. 9 is an exploded isometric view of a third embodiment of the present invention as shown from the top of the utensil.

FIG. 10 is an exploded isometric view of a third embodiment of the present invention as shown from the side of the utensil.

FIG. 11 is an isometric view of a third embodiment of the present invention assembled and shown from the side.

FIG. 12 is sectional view of a third embodiment of the present invention demonstrating the structure of the embodiment as a whole.

FIG. 13 is an exploded isometric view of a third embodiment of the present invention as shown from the bottom of the utensil.

FIG. 14 is an isometric view of a fourth embodiment of the present invention.

FIG. 15 is an example of a known disposable utensil.

FIG. 16 is illustrates a load bearing simulation used to test both embodiments of the present invention and known disposable utensils.

FIG. 17 shows an alternate embodiment of the present invention having a hinge along at least one surface of the utensil.

FIG. 18 shows the utensil of FIG. 17 being closed to overlay the top and bottom sections forming a complete utensil in accordance with the present invention.

FIG. 19 shows another alternate embodiment of the present invention having a hinge along at least one surface of the utensil.

FIG. 20 shows the utensil of FIG. 19 being closed to overlay the top and bottom sections forming a complete utensil in accordance with the present invention.

FIG. 21 is another embodiment of the present invention have a pull tab to provide access to contents stored within the utensil.

FIG. 22 is an alternate embodiment of the present invention having a partial bottom section with a rib running the length of the section.

FIG. 23 is a bottom view of an alternate embodiment of the present invention.

FIG. 24 is a perspective view of an alternate embodiment of the present invention.

FIG. 25 is an embodiment of the present invention having a flip end access point.

FIG. 26 is an embodiment of the present invention illustrating an alternative rib structure.

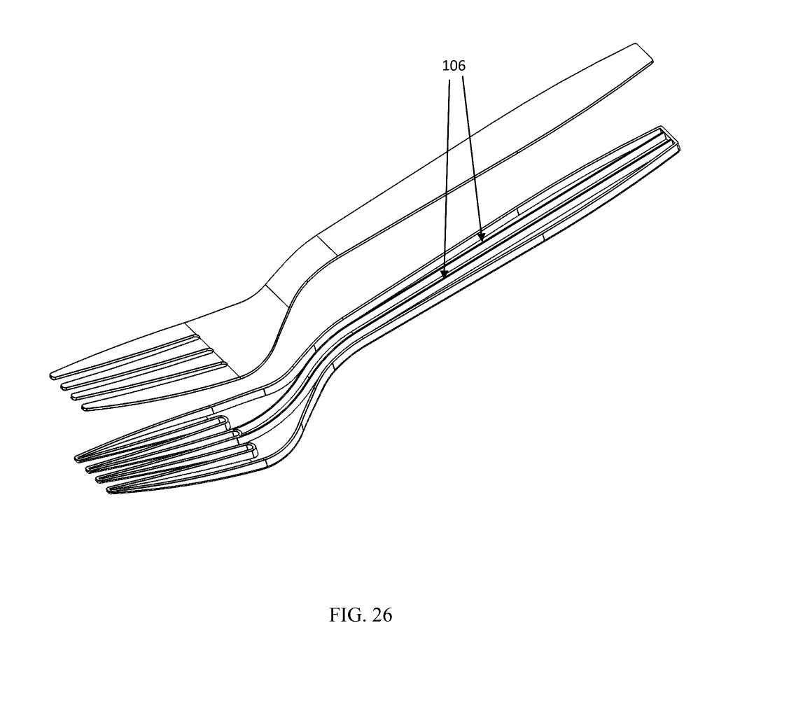

FIG. 27 is a chart illustrating utensil weight versus displacement of an embodiment of the present invention compared to a known design.

FIG. 28 is another chart illustrating utensil weight versus displacement of an embodiment of the present invention compared to a known design.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

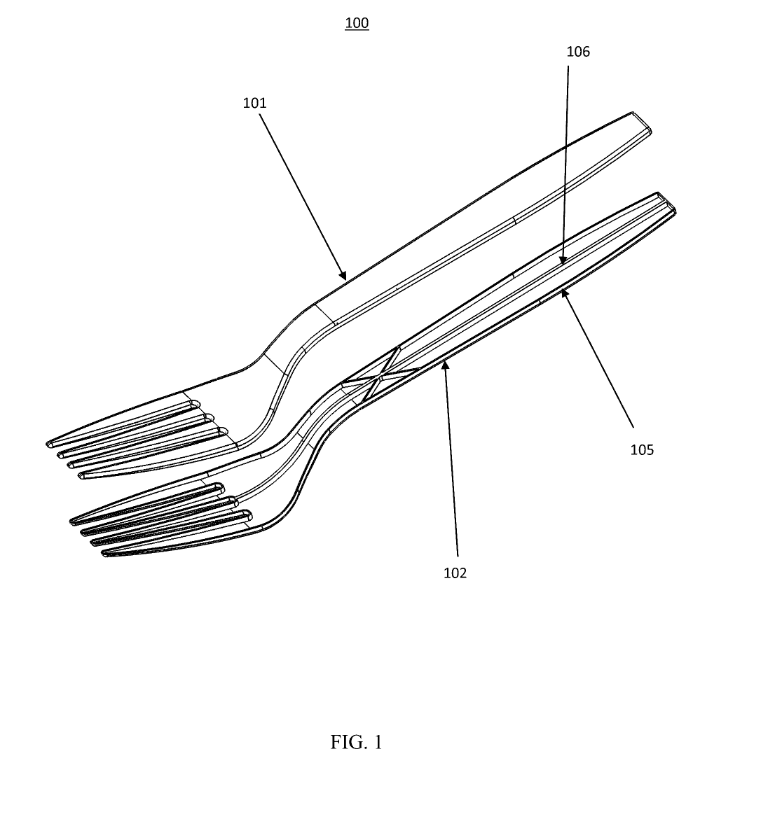

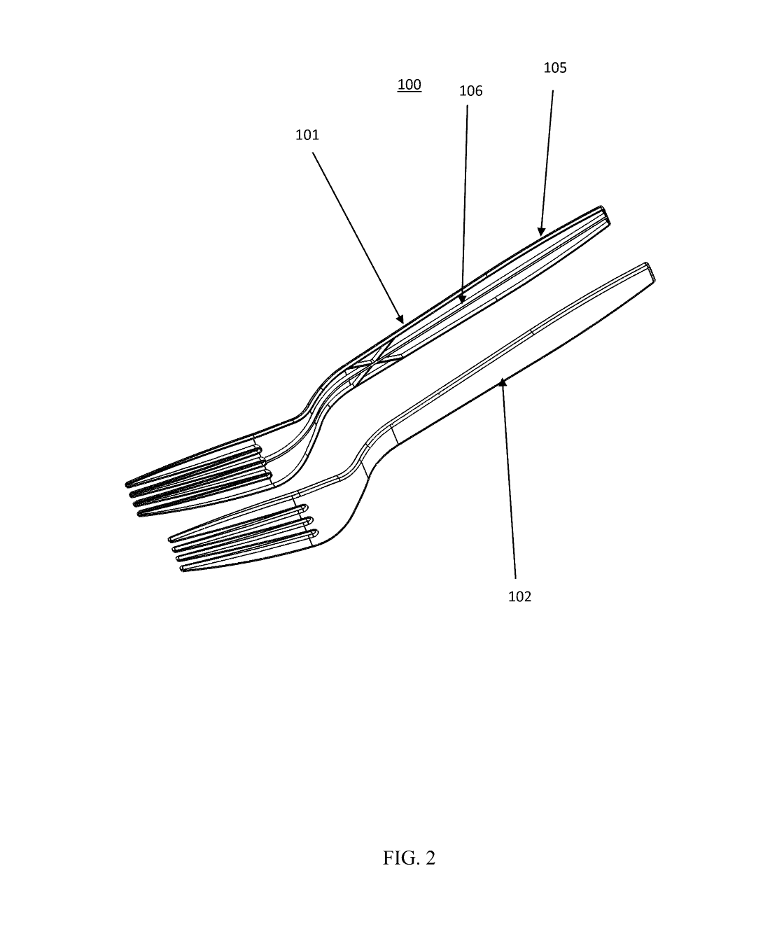

Referring now to FIGS. 1-4, there is a top view and a bottom view, respectively, of some of the components of the disposable utensil. The disposable utensil here is a fork 100. The fork 100 is comprised generally of a first section 101 and a second section. Each of the two sections are formed into a utensil, the design of which may vary. As shown, the utensil is a fork 100, however, the utensil can be virtually any utensil including knives, forks, spoons, spatulas, scoops, and the like (see below).

The first section 101 may have a coupling surface 105 that protrudes or extends from the first section 101. The second section 102 may have a coupling surface 105 protruding or extending therefrom as well. The first section 101 and the second section 102 are substantially the same such that they form a continuous surface and utensil when brought together.

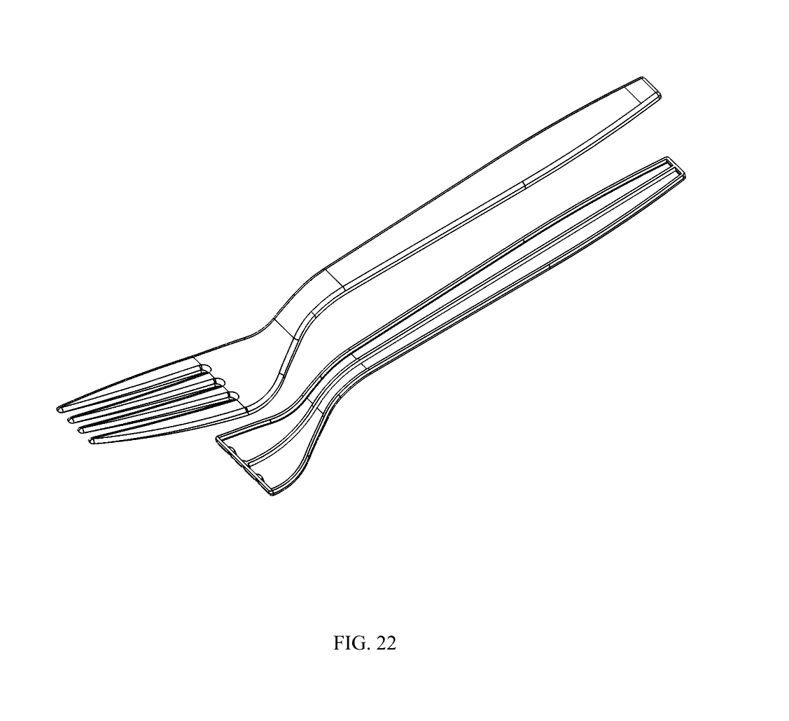

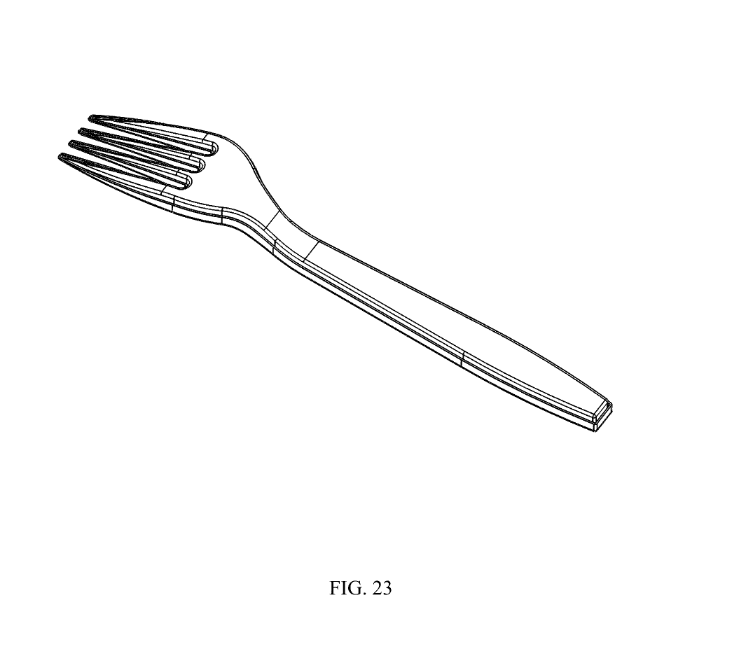

In some instances, the sections are dissimilar in size and shape and may not overlay one another, for example, see FIGS. 22 and 23. In FIG. 22, there is an “incomplete” section where the tines may be less supported by the handle receives the additional support from the two section being brought together. In FIG. 23, the two sections have a “shoe box” type arrangement where one section fits within another section. However, it may be preferable to have the section be substantially the same in size as shown in FIGS. 1-4 in order to ensure the proper rigidity and strength.

Further, the utensil 100 may have ribs 106. The ribs 106 are raised structures that provide additional strength and support to the utensil 100. The ribs 106 may be formed from the same or a different material as the remaining utensil body. In some embodiments, the ribs 106 are permanently positioned, whereas in other embodiments the ribs 106 are repositionable according to user needs and specifications. The ribs 106 may be arranged in a number of configurations (see FIGS. 1, 2, and 22) to strategically provide strength to particular areas of the utensil 100 or the utensil 100 as a whole. If the ribs 106 are present on both the first section 101 and the second section 102, it is preferable that the rib structure on each is the same thereby aligning the ribs 106 when the two sections are brought together. Any of the embodiments described herein may have the ribs 106 whether or not they are explicitly shown on the particular embodiment in the drawings.

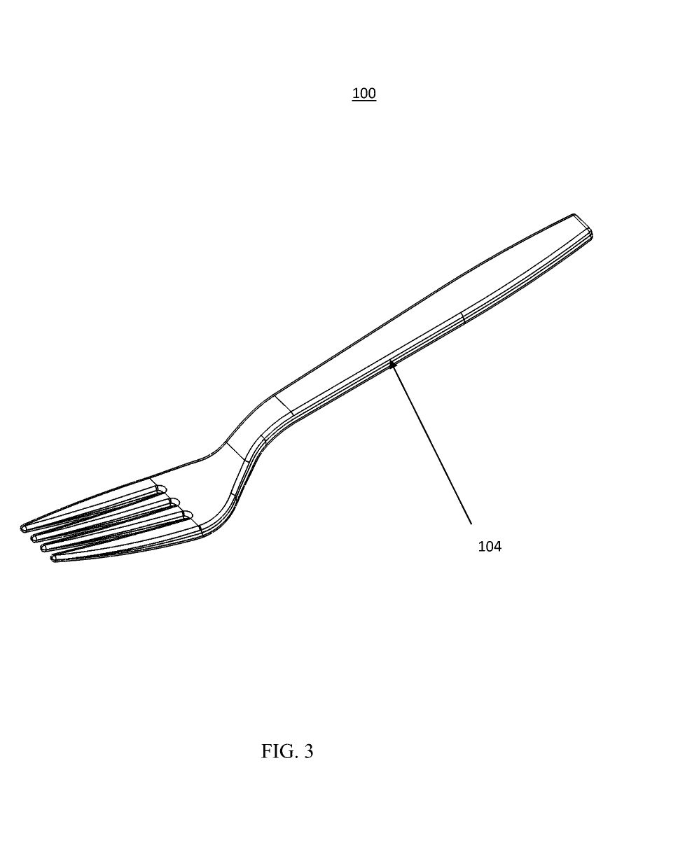

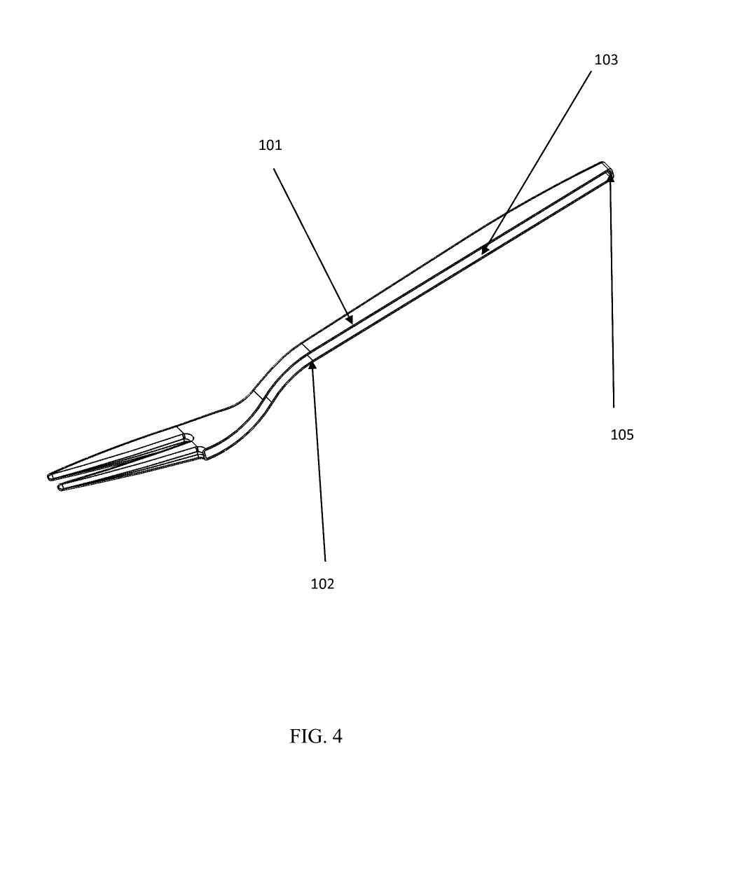

In FIG. 3, the two sections have been coupled forming a unitary utensil. The fork 100 has been coupled along the perimeter of the fork 100 leaving the interior hollow as shown in FIG. 4. The bond 104 may be achieved via snaps, clasps, interlocking mechanisms, glue, sonic welding, and the like or a combination thereof. It is preferable that once joined, the sections cannot be separated save for destroying the structural integrity of the fork 100.

FIG. 4 demonstrates from a section side view how the two section of the utensil interact with one another. The two sections are coupled along the perimeter of each section causing a hollow space or chamber to permeate the entire utensil. This causes reinforcement to the utensil to be applied in strategic locations and be borne by these coupled surfaces, allowing for greater strength, a decrease in required materials, and decreased cost to consumers.

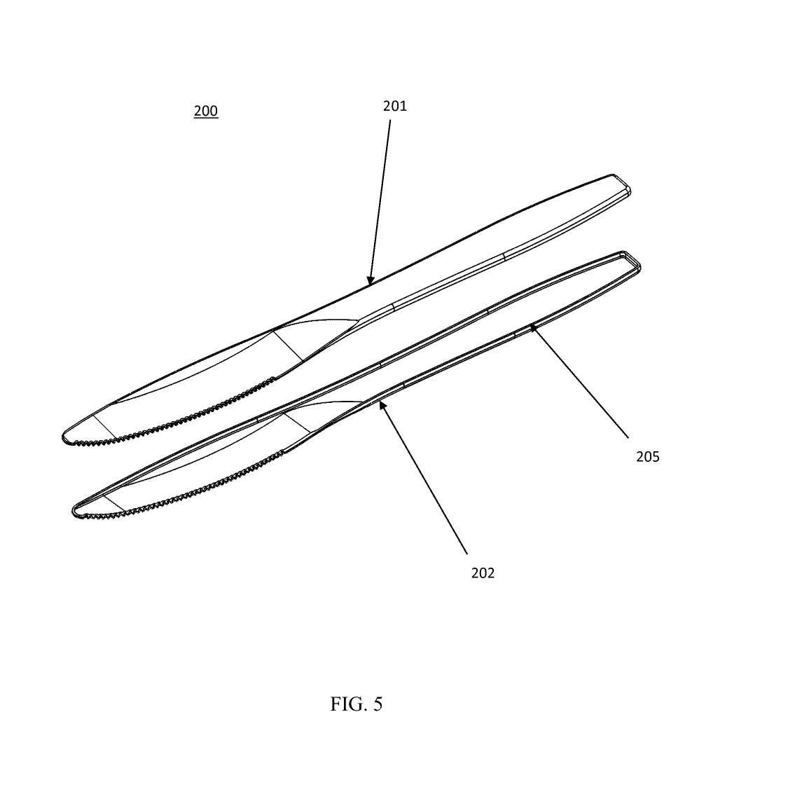

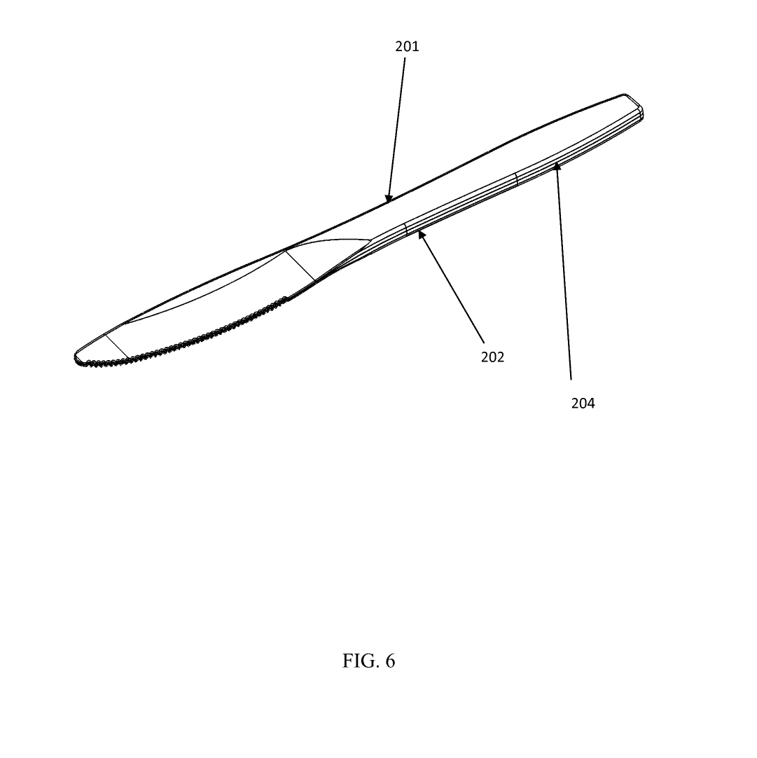

Referring now to FIGS. 5-7, the utensil is a knife 200. The first section 201 may have a coupling surface 205 that protrudes or extends from the first section 201. The second section 202 may have a coupling surface 205 protruding or extending therefrom as well. The first section 201 and the second section 202 are substantially the same such that they form a continuous surface and utensil when brought together.

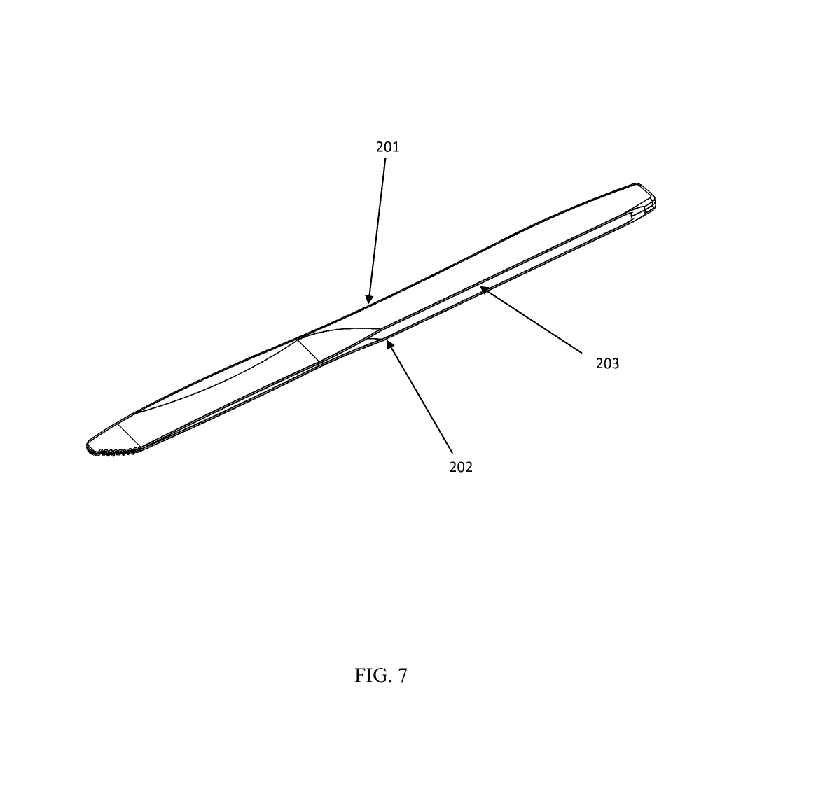

Preferably, the two sections are coupled forming a unitary utensil. The knife 200 has been coupled along the perimeter of the knife 200 leaving the interior hollow as shown in FIG. 7. The bond 204 may be achieved via snaps, clasps, interlocking mechanisms, glue, sonic welding, and the like or a combination thereof. It is preferable that once joined, the sections cannot be separated save for destroying the structural integrity of the knife 200.

FIG. 7 demonstrates from a section side view how the two sections of the utensil interact with one another. The two sections are coupled along the perimeter of each section causing a hollow space or chamber to permeate the entire utensil. This causes reinforcement to the utensil to be applied in strategic locations and be borne by these coupled surfaces, allowing for greater strength, a decrease in required materials, and decreased cost to consumers.

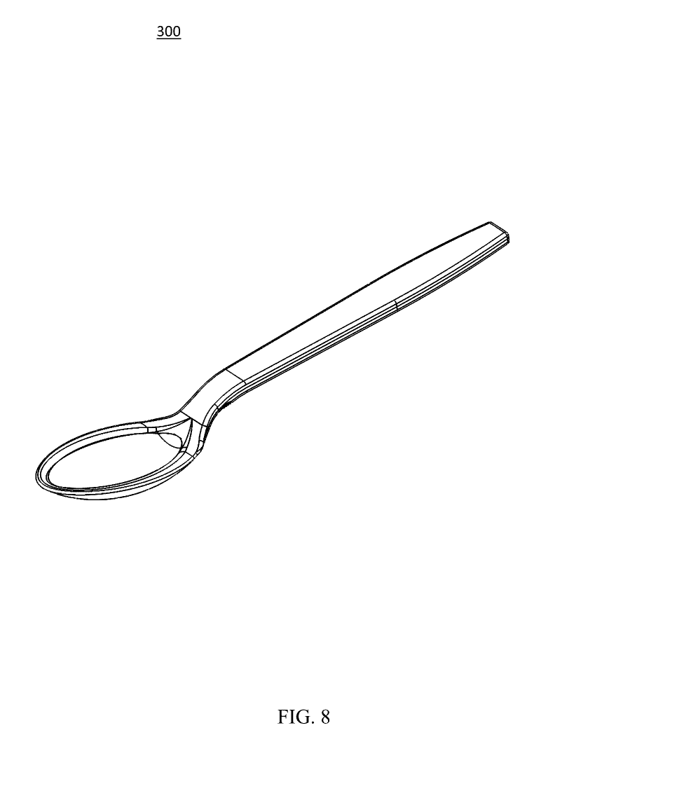

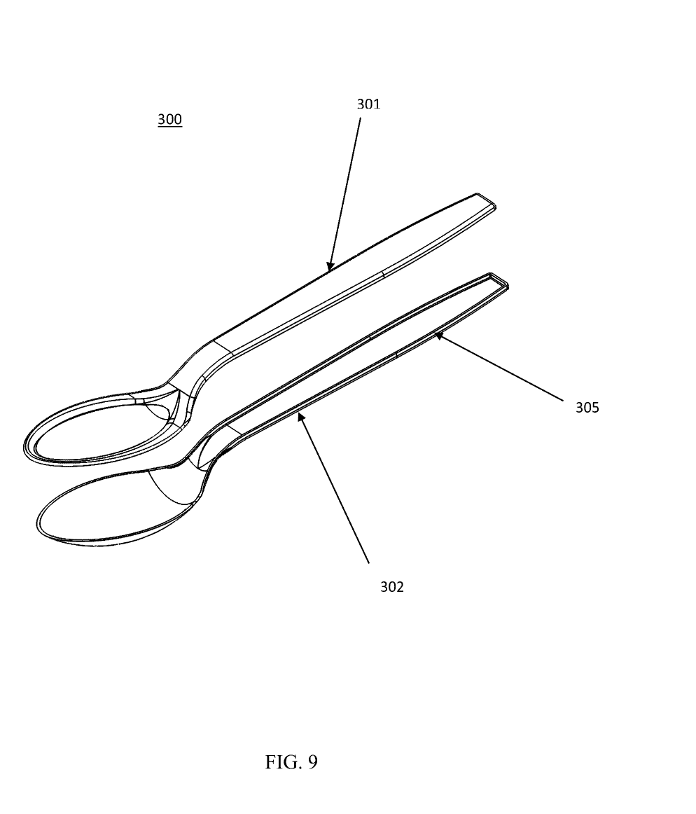

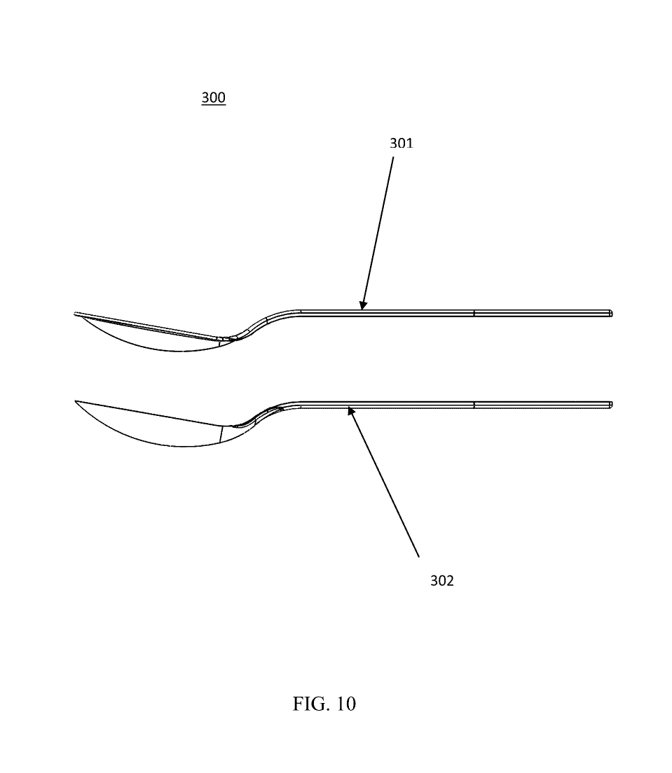

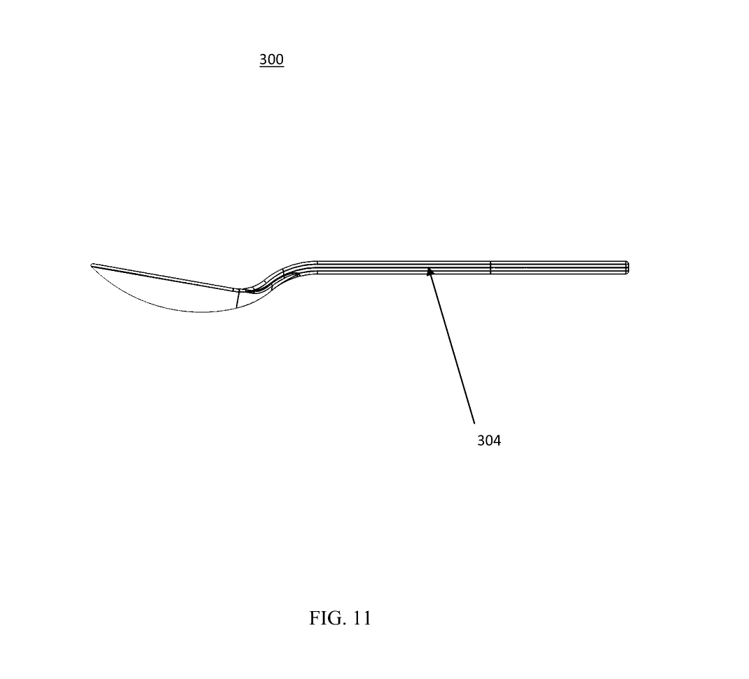

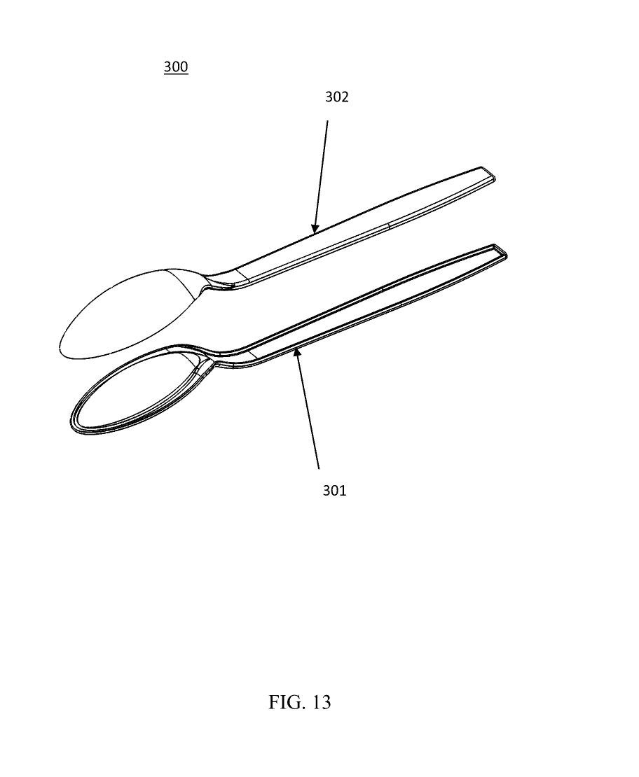

Referring now to FIGS. 8-13, the utensil is a spoon 300. The first section 301 may have a coupling surface 305 that protrudes or extends from the first section 301. The second section 302 may have a coupling surface 305 protruding or extending therefrom as well. The first section 301 and the second section 302 are substantially the same such that they form a continuous surface and utensil when brought together.

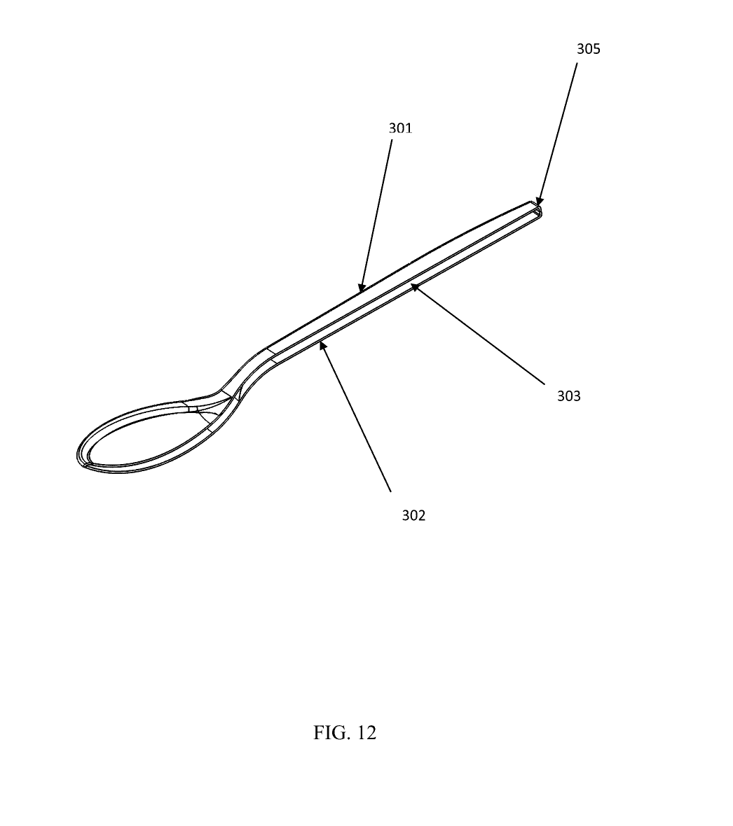

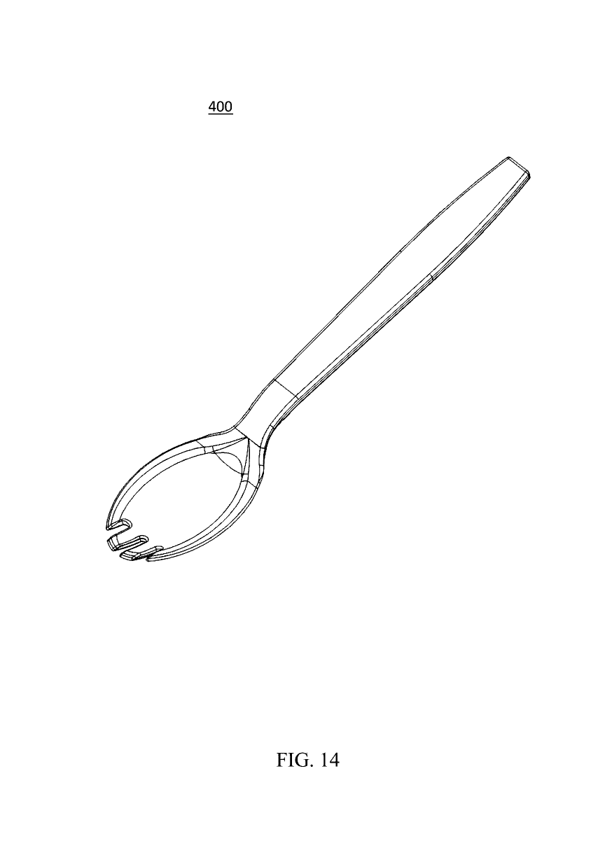

Preferably, the two sections are coupled forming a unitary utensil. The spoon 300 has been coupled along the perimeter of the spoon 300 leaving the interior hollow as shown in FIG. 12. The bond 304 may be achieved as previously described herein. It is preferable that once joined, the sections cannot be separated save for destroying the structural integrity of the spoon 300. FIG. 12 demonstrates from a section side view how the two sections of the utensil interact with one another. The two sections are coupled along the perimeter of each section causing a hollow space or chamber to permeate the entire utensil. A modified spoon 400, or “spork” is shown in FIG. 14. The “spork” 400 preferably has a similar construction to the spoon 300 as shown herein.

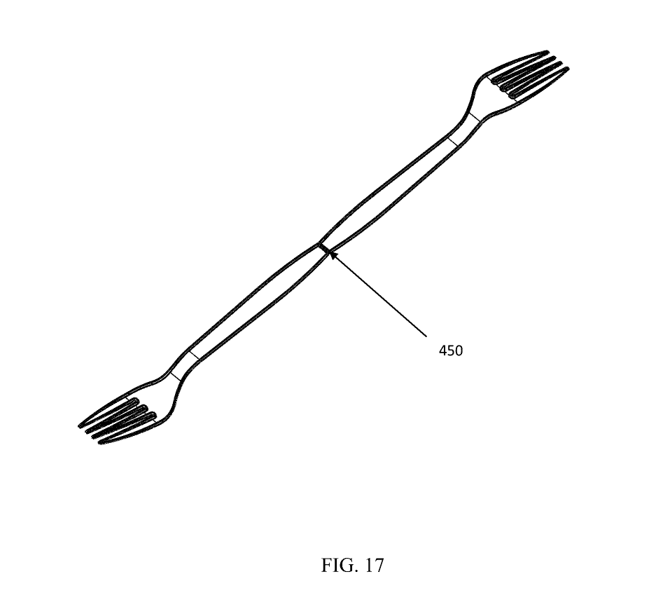

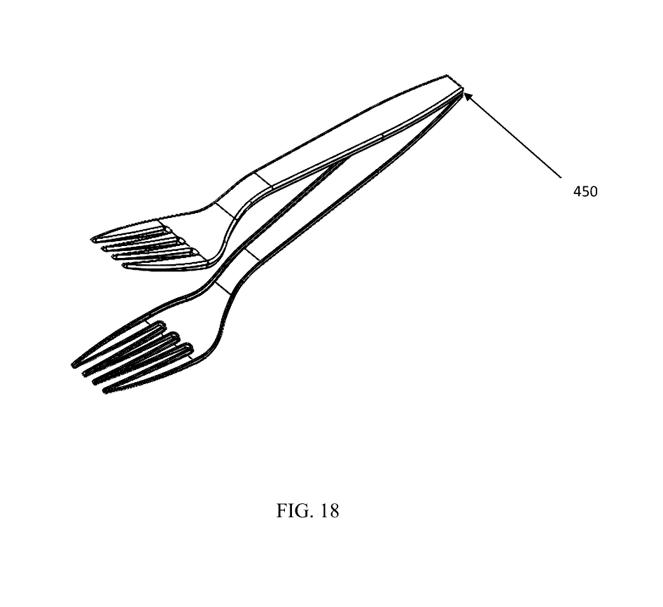

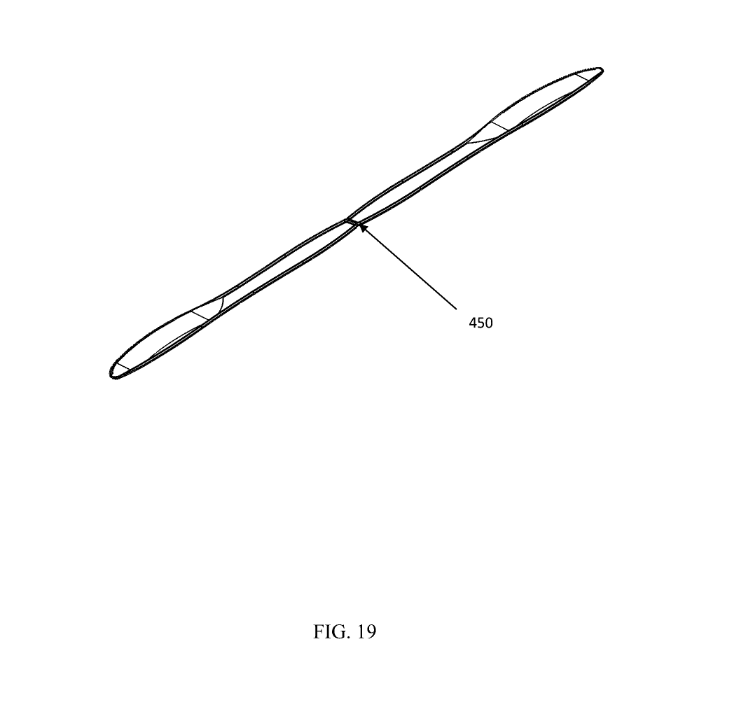

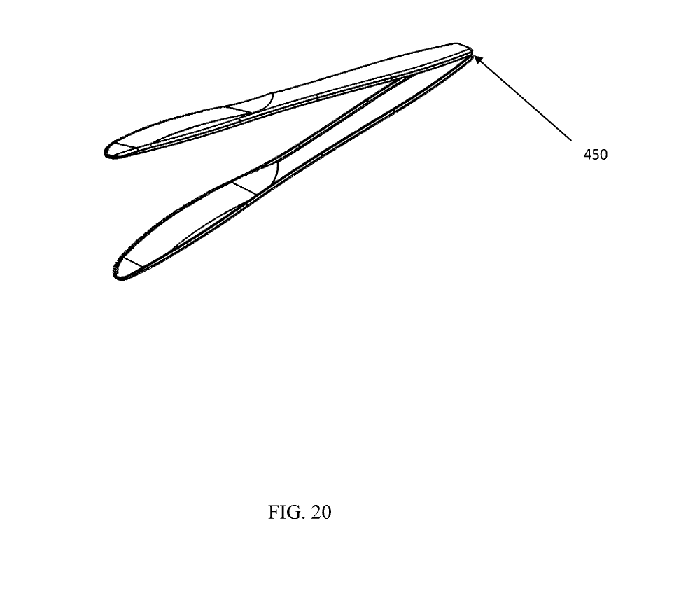

In FIGS. 17-20, the utensil(s) are shown with a hinge 450. The hinge 450 may take a number of forms and is preferably a thinner wall formed from the same or a different material than the remainder of the utensil that allows for rotation of one section in relation to the other section of the utensil. In some embodiments, there are male/female connectors to allow the utensil to snap together. In other embodiments, the male/female connectors used may allow the sections to be permanently or removably coupled to one another. In other embodiments, the hinge 450 allows the two sections to be completely removed or separated from one another.

The utensils shown in FIGS. 1-20 and others not explicitly shown herein may have a number of features comprising each embodiment and some embodiments may comprises combinations of features as they are described to particular embodiments herein.

Additionally, variable wall thicknesses may assist in providing enhanced rigidity and preventing collapsing and/or breaking of the utensil. The variable wall thicknesses comprising the sections may allow for weight reductions by the thinning of material in specific areas or points of the utensil whereas allowing other areas to remain thicker and more resilient. The thicker wall could be positioned in combination with the ribs (see FIG. 1) as described above, or may be instituted without any secondary support mechanism (i.e., ribs).

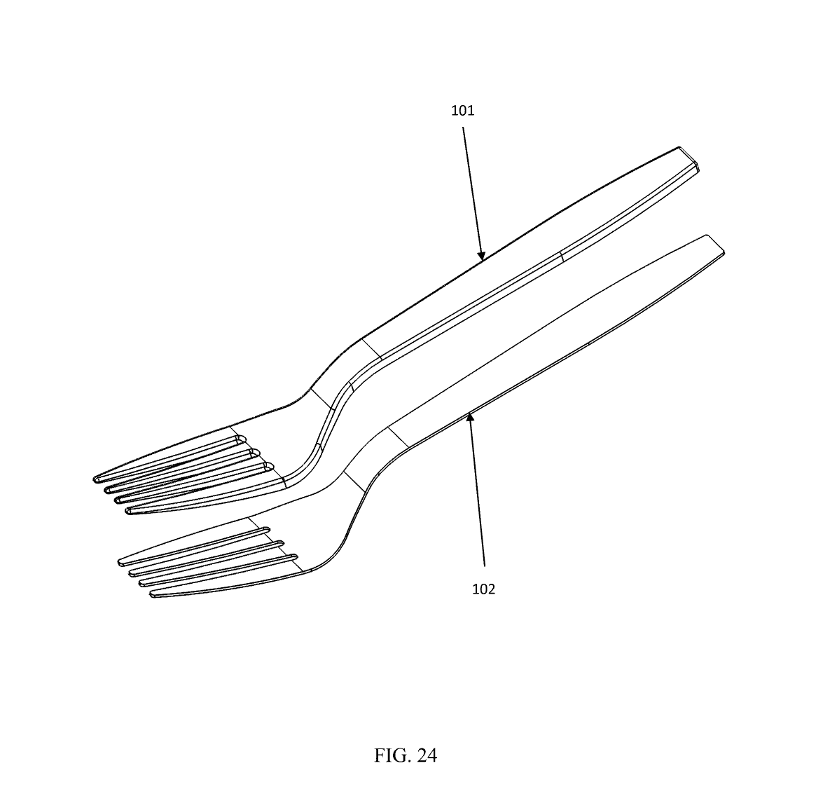

Further variable wall thicknesses may be discussed in terms of the utensil as a whole. For example, in FIG. 24, the first section 101 and the second section 102 have a different thickness. The second section 102 is substantially planar whereas the first section 101 bears the remaining structure of the utensil. Thus, the variable wall thickness may be within the individual sections or (thick vs. thin) or in terms or overall structure (planar vs. non-planar).

In some embodiments, the weight of the utensils may be further reduced via a combination of partially hollow and solid sections of the utensil as well as cavities traversing one or both (or more) sections of the utensil. For example, a particular utensil may have a plurality of apertures disposed in the handle section of the utensil. The utensil may further have ribbing coupled to the first section and second section that bears apertures as well. Thus, the entire handle may have a “honeycomb” like appearance with a solid functional member (e.g. tines, bowl, etc.). Such measures may create a substantially more rigid disposable utensil while still creating a utensil that is lightweight and comprised of less material than conventional utensils.

In yet other embodiments, each section may be comprised between one and ten layers of material. In some embodiments, each section is comprised of more than ten layers of material. For example, the utensil may be comprised of paper and the additional layers for each section may provide the necessary rigidity to the utensil. Any of the layers may further be coated in wax or other water resistant or water proof materials. In some embodiments, the layers may be coated in or comprised of antimicrobial materials.

In yet other embodiments, the utensil contains various electronic components which may be powered by a powered source such as a battery. The electronics may provide for various displays, timers, lights, sounds, vibrations, etc. for the entertainment of the user primarily children. Further electronics may include monitoring for medical purposes (e.g., body temperature, heartbeat sensor, etc.), temperature of food, and strain/stress placed on the utensil by the user. Other uses may readily be apparent to those having ordinary skill in the art.

In still other embodiments, the utensil may be filled with various medicines such as liquids, powders, and cough syrups.

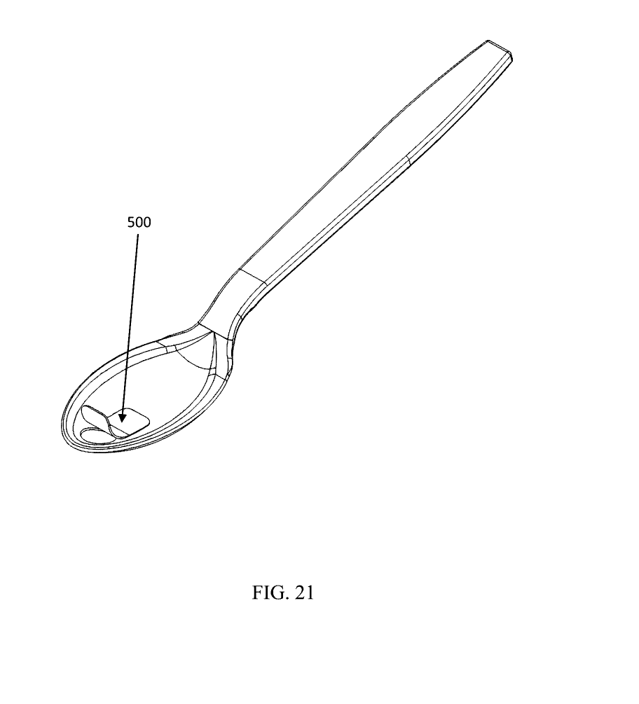

In still other embodiments, the utensil may be filled with various food products such as drink powders, tea, coffee, seasonings, and condiments. Such products may be accessible via an opening covered by a removable pull tab 500 as shown in FIG. 21.

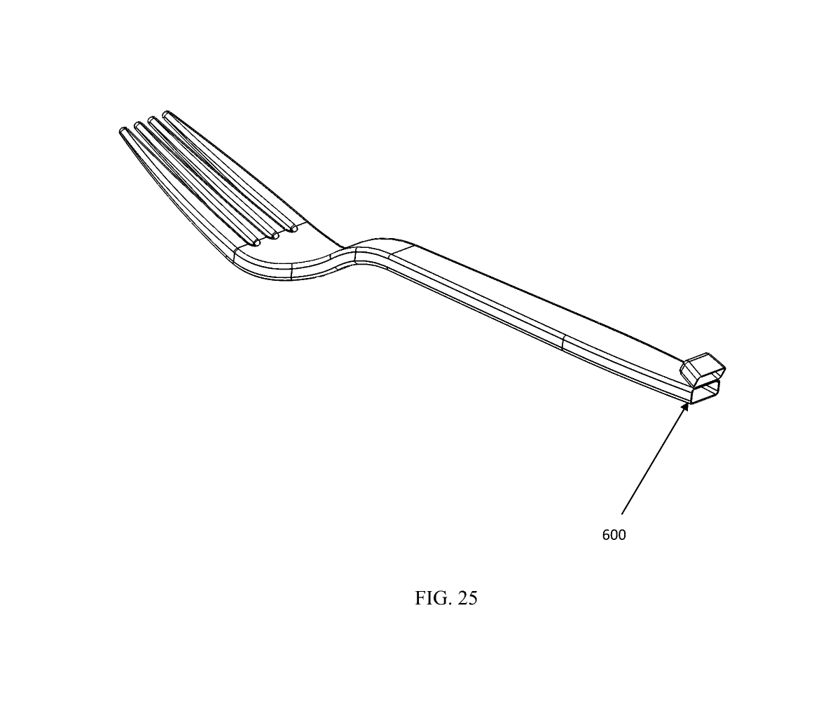

In still other embodiments, the utensil has a frangible area 600 specifically designed to snap, rupture, split, or fracture open to expose the contents contained inside interstitial space as shown in FIG. 25.

In still other embodiments, the utensil may be manufactured from material that changes color depending up the temperature, or a glow in the dark material.

In still other embodiments, the utensil may have various fillers that serve as either decorative or structural enhancers. For example, the utensil may be clear or translucent or transparent and be filled with confetti or sparkles or liquid or other objects. The various fillers may be lightweight and positioned within the utensil in such a manner as to provide additional strength to the utensil as a whole.

### EXAMPLES

### Example 1

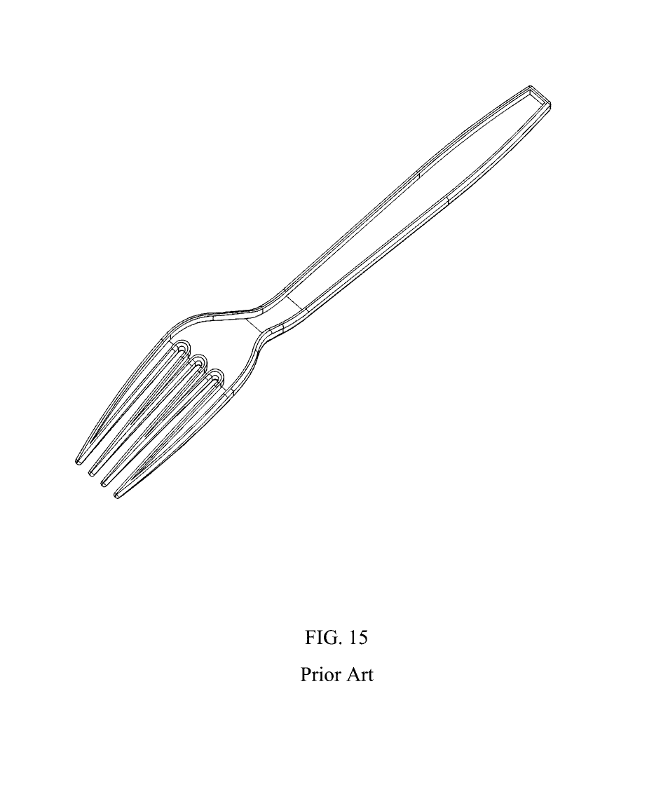

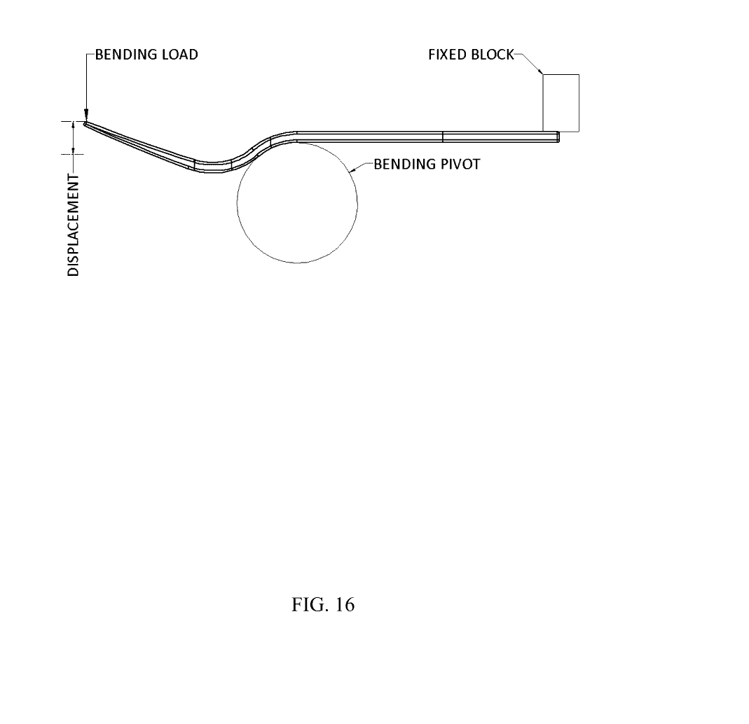

Embodiments of the present invention (see FIGS. 1-4) minus the internal rib structures were tested against embodiments of a known utensil design (see FIG. 15). The embodiment of the present invention comprised of a two section utensil fused around a periphery with a cavity contained therein. The known utensil featured a single piece construction bearing a “u-shaped” design when viewed cross-sectionally. Each utensil was tested using SOLIDWORKS® Simulation computer software using the set up as shown in FIG. 16. Table 1, shown below, details the varying wall thickness of the respective sections of the preferred embodiment as tested, the overall weight of the utensil, and the displacement experienced by the utensil when a 2.2. lb. load was applied to one of the tines of the utensil.

TABLE 1

| WALL THICKNESS | FORK WEIGHT | DISPLACEMENT |
|---|---|---|
| inches | lbs | inches |
| 0.055 | 0.0178 | 0.0294 |
| 0.050 | 0.0166 | 0.0305 |
| 0.045 | 0.0153 | 0.0326 |
| 0.040 | 0.0140 | 0.0353 |
| 0.035 | 0.0125 | 0.0390 |
| 0.030 | 0.0109 | 0.0448 |
| 0.025 | 0.0093 | 0.0530 |
| 0.020 | 0.0076 | 0.0662 |
| 0.015 | 0.0058 | 0.0887 |
| 0.010 | 0.0040 | 0.1350 |

Table 2, shown below, contains the same three variables from left to right as outlined in Table 1. However, table 2 was created using data obtained from placing the load on the known utensil design of FIG. 15.

TABLE 2

| | | |
|---|---|---|
| 0.090 | 0.0174 | 0.045 |
| 0.080 | 0.0162 | 0.050 |
| 0.070 | 0.0148 | 0.058 |
| 0.060 | 0.0132 | 0.069 |
| 0.050 | 0.0114 | 0.086 |
| 0.040 | 0.0094 | 0.120 |
| 0.030 | 0.0074 | 0.165 |
| 0.020 | 0.0053 | 0.294 |

From Table 1 and Table 2 above, it is apparent that the present invention demonstrates a greater rigidity (less displacement of tine) than that of the known design. Further, the weight of the present invention was less than that of the known design as the same wall thickness. The data obtained from the comparisons can be placed into charts that illustrate the displacement experienced by each utensil, known or present invention, at a variety of particular weights (Table 3) or the weight of each utensil at a particular unit of displacement (Table 4).

TABLE 3

| | | Present | |
|---|---|---|---|
| Fork | Prior Art | Invention | Displacement |
| Weight | Displacement | Displacement | Reduction |
| (Lbs.) | (inch.) | (inch.) | (%) |
| 0.018 | 0.0434 | 0.0254 | 171% |
| 0.017 | 0.0474 | 0.0269 | 176% |
| 0.016 | 0.0521 | 0.0287 | 182% |
| 0.015 | 0.0577 | 0.0306 | 188% |
| 0.014 | 0.0643 | 0.0329 | 195% |
| 0.013 | 0.0722 | 0.0355 | 203% |
| 0.012 | 0.0818 | 0.0386 | 212% |
| 0.011 | 0.0938 | 0.0422 | 222% |
| 0.010 | 0.1089 | 0.0466 | 234% |
| 0.009 | 0.1285 | 0.0519 | 247% |
| 0.008 | 0.1545 | 0.0586 | 263% |
| 0.007 | 0.1905 | 0.0673 | 283% |
| 0.006 | 0.2425 | 0.0789 | 307% |
| 0.005 | 0.3227 | 0.0953 | 339% |

The above table clearly illustrates the reduction in tine displacement experienced by the embodiments of the present invention as compared to the known designs when the fork weight is consistent between the two designs. At a weight of 0.018 lbs., the present design resulted in a 171% improvement of displacement of the tine. However, as the weight of the utensil decreases the overall reduction in displacement greatly and surprisingly improves as well. For example, lowering the weight of the utensil from 0.018 lbs. to 0.017 lbs. only resulted in an improved displacement reduction of about 5%. However, a reduction in weight from 0.006 lbs. to 0.005 lbs. resulted in a displacement reduction of about 32% over the known design.

TABLE 4

| | Known | Present | |
|---|---|---|---|
| Utensil | Utensil | Invention | Weight |
| Displacement | Weight | Weight | Reduction |
| (inch.) | (lbs.) | (lbs.) | (%) |
| 0.05 | 0.0162 | 0.0108 | 33% |
| 0.06 | 0.0144 | 0.0091 | 37% |
| 0.07 | 0.0131 | 0.0078 | 40% |
| 0.08 | 0.0120 | 0.0069 | 43% |
| 0.09 | 0.0112 | 0.0061 | 45% |
| 0.10 | 0.0104 | 0.0055 | 47% |
| 0.11 | 0.0098 | 0.0050 | 49% |
| 0.12 | 0.0093 | 0.0046 | 50% |
| 0.13 | 0.0088 | 0.0043 | 51% |
| 0.14 | 0.0084 | 0.0040 | 52% |
| 0.15 | 0.0081 | 0.0037 | 54% |
| 0.16 | 0.0077 | 0.0035 | 54% |
| 0.17 | 0.0074 | 0.0033 | 55% |
| 0.18 | 0.0072 | 0.0031 | 56% |

Further, Table 4 demonstrates that not only is a surprising reduction of displacement seen between the present invention and known designs, but a surprising weight reduction is also exhibited. As demonstrated, embodiments of the present invention weigh at least 33% to about 56% less than the known design over a displacement range of about 0.05 to about 0.18 inches. Such a reduction in weight is surprising enough on its own, but coupled with the improved displacement (increased rigidity) with a reduction in weight is quite monumental.

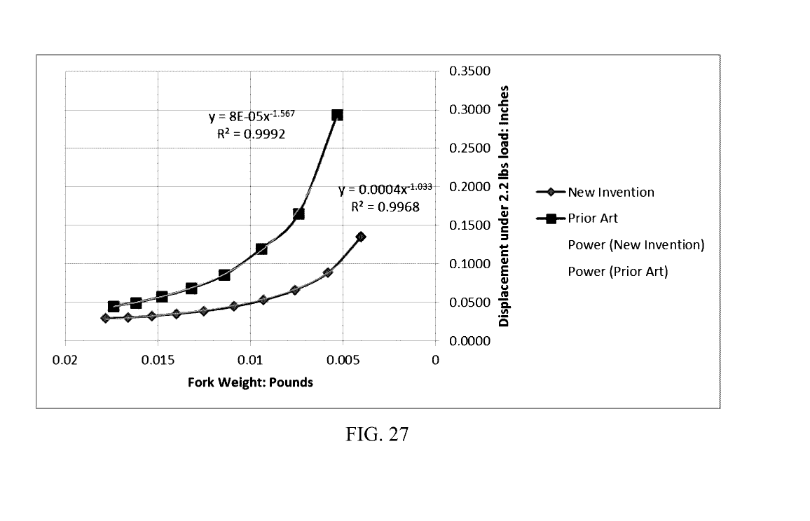

FIG. 27 was created with values obtained in the tables above and plotted as a function of utensil weight (lbs.) versus displacement under a 2.2 lb. load. The figure unequivocally shows that the design and structure of the present invention is vastly and surprisingly superior to the known designs. In all instances, the present invention and its embodiments exhibited a lesser weight while maintaining a lesser displacement of the tine(s) under the simulated load.

### Example 2

Embodiments of the present invention (see FIGS. 1-4) including the internal rib structures as explicitly shown in the drawings, were tested against embodiments of a known utensil design (see FIG. 15). The embodiment of the present invention comprised of a two section utensil fused around a periphery with a cavity contained therein. Each utensil was tested using SOLIDWORKS Simulation using the set up as shown in FIG. 16. Table 5, shown below, details the varying wall thickness of the respective sections of the preferred embodiment as tested, the overall weight of the utensil, and the displacement experienced by the utensil when a 2.2 lb. load was applied to one of the tines of the utensil.

TABLE 5

| WALL THICKNESS | FORK WEIGHT | DISPLACEMENT |
|---|---|---|
| inches | lbs | inches |
| 0.035 | 0.0131 | 0.0305 |
| 0.030 | 0.0116 | 0.0334 |
| 0.025 | 0.0099 | 0.0378 |
| 0.020 | 0.0081 | 0.0449 |
| 0.015 | 0.0062 | 0.0575 |
| 0.010 | 0.0042 | 0.0830 |

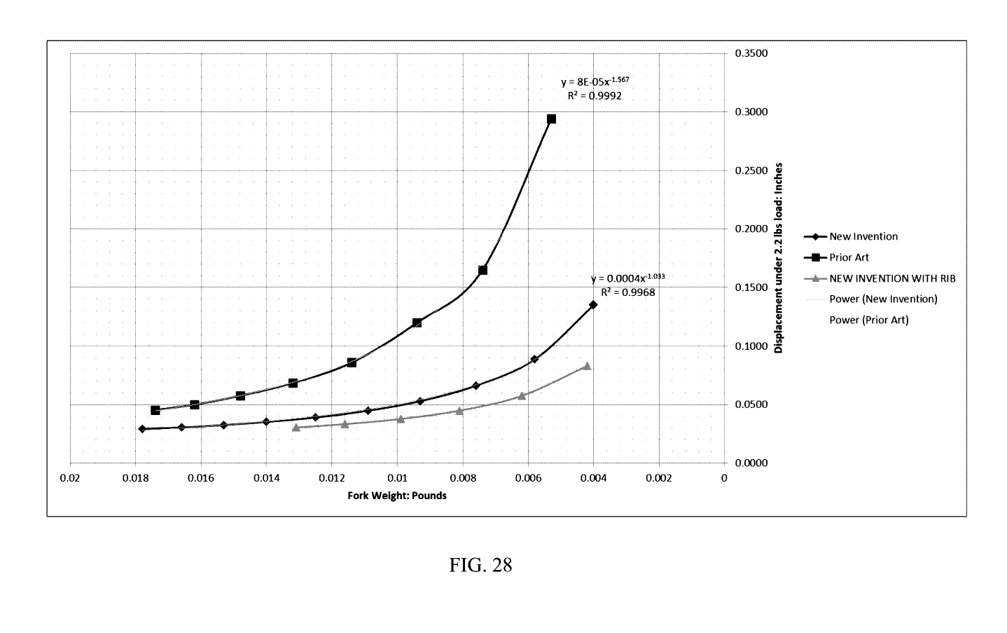

FIG. 28 was created with values obtained and outlined in the Table 5 above, as well as those as described in Example 1, and plotted as a function of utensil weight (lbs.) versus displacement under a 2.2 lb. load. The figure unequivocally shows that the ribbed design and structure of the present invention is vastly and surprisingly superior to the known designs including that of the non-ribbed design described herein. Regardless, in all instances, the present invention and its embodiments exhibited a lesser weight while maintaining a lesser displacement of the tine(s) under the simulated load than the previously known structures.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. An eating utensil comprising:
a first section substantially bearing a shape of a utensil,
wherein the first section has a first coupling surface disposed around a periphery of the first section;
a second section having a shape that is substantially the same as the first section,
wherein the second section has a second coupling surface disposed around a periphery of the second section; and
wherein the first section and the second section are coupled along at least a portion of the first and the second coupling surface.

2. The utensil of claim 1 further comprising at least one rib disposed along an inner surface of the first section and/or the second section.

3. The utensil of claim 1 wherein the utensil is a spoon, fork, or knife or a combination thereof.

4. The utensil of claim 1 wherein the first coupling surface and the second coupling surface have a height greater than that of the first section and the second section respectively.

5. The utensil of claim 1 wherein the utensil comprises metal, plastic, plant products, biodegradable materials, or any combination thereof.

6. The utensil of claim 1 further comprising a wax coating disposed on at least an outer surface of the first section and the second section.

7. The utensil of claim 1 wherein the first section and the second section are bonded using glue, adhesives, sonic welding, solvent welding, or any combination thereof.

8. The utensil of claim 1 wherein the first section is substantially planar and coupled to the second section, the second section having the remaining utensil structure thereon.

9. The utensil of claim 1 further comprising a hinge, the hinge coupling the first section to the second section.

10. The utensil of claim 1 further comprising snaps, clasps, interlocking mechanisms, or alignment features or a combination thereof.

11. A utensil comprising:
a utensil body defining an interstitial space therein,
wherein the utensil is configured to distribute a load around a periphery of the utensil.

12. The utensil of claim 11 wherein the utensil body forms a continuous surface.

13. The utensil of claim 11 wherein the utensil body contains at least one aperture disposed therein.

14. The utensil of claim 11 further comprising at least one power source and at least one electronic component.

15. The utensil of claim 14 wherein the electronic component is a display, light source, sensor, timer, sound generator, thermocouple, or vibrator.

16. The utensil of claim 11 further comprising at least one rib.

17. The utensil of claim 16 wherein the at least one rib traverses a length or a width of an interior surface of the utensil.

18. The utensil of claim 11 wherein the material exhibits a variable thickness.

19. The utensil of claim 5 wherein the utensil is comprised of paper.

20. The utensil of claim 11 further comprising at least one filler contained within the utensil.

21. The utensil of claim 20 wherein the at least one filler provides additional structural support and strength to the utensil.

22. The utensil of claim 20 wherein the at least one filler is at least one food product or medicine.

23. The utensil of claim 20 wherein the at least one filler is confetti, sparkles, or liquids, or a combination thereof.

24. The utensil of claim 20 further comprising a frangible area configured to snap, rupture, split, or fracture open to expose the at least one filler contained within the utensil.

25. The utensil of claim 20 wherein the at least one filler is retained by a removable pull tab.

26. The utensil of claim 25 wherein the removable pull tab is disposed over an aperture in the first and/or second section of the utensil.

27. An eating utensil comprising:
a first section substantially bearing a shape of a utensil,
wherein the first section has a first coupling surface disposed around a periphery of the first section;
a second section having a shape that is substantially the same as the first section,
wherein the second section has a reduced size and shape, and
wherein the first section and the second section are coupled along at least a portion of the first and the second coupling surface.

28. The utensil of claim 27 wherein an inner wall of the first section abuts an inner wall of the second section when the sections are joined.

29. The utensil of claim 27 wherein an outer wall of the first section abuts an inner wall of the second section.

30. The utensil of claim 27 wherein the first section and the second section, when joined, form a utensil body having at least one hollow section and at least one solid section.
